(19) United States
(12) Patent Application Publication
(10) Pub. No.: US 2024/0160750 A1
(43) Pub. Date: May 16, 2024

(54) TRANSFORMING CONTAINER IMAGES INTO CONFIDENTIAL WORKLOADS

(71) Applicant: Red Hat, Inc., Raleigh, NC (US)

(72) Inventors: Sergio Lopez Pascual, Madrid (ES); Alice Frosi, Grasbrunn (DE)

(21) Appl. No.: 17/987,688

(22) Filed: Nov. 15, 2022

(51) Int. Cl. G06F 21/60; G06F 8/61

(52) U.S. Cl. CPC G06F 21/602; G06F 8/63

(57) ABSTRACT

A request to create a confidential container image is received from a client device. The request includes a container image. Attestation parameters are written into a first partition of a disk image within the confidential container image. An encrypted volume is created in a second partition of the disk image. A workload is copied from the container image to the encrypted volume. The confidential container image is registered with an attestation server using the attestation parameters.

### TECHNICAL FIELD

Aspects of the present disclosure relate to secure cloud computing, and more particularly, to generating and managing a confidential container image comprising a workload, that can be deployed in a cloud computing environment.

### BACKGROUND

Computing systems may rely on cloud computing environments to execute one or more applications and/or to provide computing services. Container images are a convenient way of packaging applications for deployment. Cloud computing environments may provide computing resources that can be used by the computing systems to serve as repositories for container images. In particular, container images can be requested and retrieved from centralized repositories that provide security and versioning.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments without departing from the spirit and scope of the described embodiments.

FIG. 1 is a block diagram that illustrates an example confidential container architecture, in accordance with some embodiments.

FIG. 2 is a flow diagram of a transformation process for a confidential container image, in accordance with some embodiments.

FIG. 3 is a depiction of an example of a client device transmitting a request to create a confidential container image in a confidential container architecture, in accordance with embodiments of the disclosure, in accordance with embodiments of the disclosure.

FIG. 4 is a depiction of an example of a client device transmitting a request to deploy a confidential container of a confidential container architecture, in accordance with embodiments of the disclosure.

FIG. 5 is a depiction of an example of a client device transmitting an update to a confidential container of a confidential container architecture, in accordance with embodiments of the disclosure.

FIG. 6 is a depiction of an example of a client device transmitting a request to revoke a confidential container of a confidential container architecture, in accordance with embodiments of the disclosure.

FIG. 7 is a component diagram depicting an example confidential container architecture, in accordance with embodiments of the disclosure.

FIG. 8 is a flow diagram of a method of provisioning a confidential container, in accordance with some embodiments.

FIG. 9 is a flow diagram of a method of deploying a confidential container, in accordance with some embodiments.

FIG. 10 is a flow diagram of a method of updating a confidential container, in accordance with some embodiments.

FIG. 11 is a flow diagram of a method of revoking a confidential container, in accordance with some embodiments.

FIG. 12 is a block diagram of an example computing device that may perform one or more of the operations described herein, in accordance with some embodiments of the present disclosure.

### DETAILED DESCRIPTION

Containers are a standard package of software that bundle an application's code together with related configuration files and libraries, and the dependencies required for the application to run. Such a software bundle can allow organizations to deploy applications seamlessly and more efficiently across environments. This workflow allows for agility, portability, and rapid scalability in security implementation.

However, while container images are a convenient way of packaging applications for deployment, container images don't meet the confidentiality requirements to be safely deployed into a confidential computing trusted execution environment (TEE). In order to ensure the confidentiality and protection of sensitive data, the storage used by a container needs to be encrypted. Furthermore, an environment, such as a container, to which a workload is to be deployed needs to be subject to verification and attestation by an external service. The conventional container ecosystem lacks the tools to configure and secure such workloads.

Rather than trying to encrypt every layer of the open container initiative (OCT) image, which can result in significant complexity with few benefits in a confidential computing context, aspects of this disclosure flatten the contents of the OCI image into a single layer within an encrypted volume, providing a simpler solution that uses a single key. In addition, the parameters needed to launch the confidential workload, e.g., the TEE, workload, and attestation server parameters, are included in the image, fitting better with the state-of-the-art of Virtualization-based TEEs and providing a more flexible image that can support a wider range of Confidential Computing technologies.

Aspects of the present disclosure address the above-noted and other deficiencies by presenting methods and systems for transforming regular container images into confidential container images that can be deployed as confidential workloads inside a TEE.

As discussed in greater detail below, upon receipt of a request to create a confidential container image, processing logic of the container encryption architecture may extract workflow parameters from a submitted container image. The processing logic may also verify that, along with a container image, TEE and attestation server parameters are provided. In some embodiments, TEE parameters and attestation server parameters include a Versioned Chip Endorsement Key (VCEK) certificate chain. In some examples, a disk image comprising two partitions is created, attestation server parameters are written to the first partition and an encrypted volume is created in the second partition using a random encryption key. In some embodiments, the submitted container image is copied into the encrypted volume. In some examples, a configuration file is created that includes the workload parameters previously extracted from the submitted container image and the TE parameters provided with the container submission as part of the request. In some aspects of the current disclosure, the processing logic of the container encryption architecture creates a second container image and copies the disk image and configuration file into it, creating a confidential container image. In some embodiments, the processing logic then enrolls this confidential container image with an attestation server, by sending a hash of the confidential container image, the random encryption key used to encrypt the volume, and the configuration file to the attestation server.

Although aspects of the disclosure may be described in the context of a confidential container architecture, embodiments of the disclosure may be applied to any computing system that configures and manages containers.

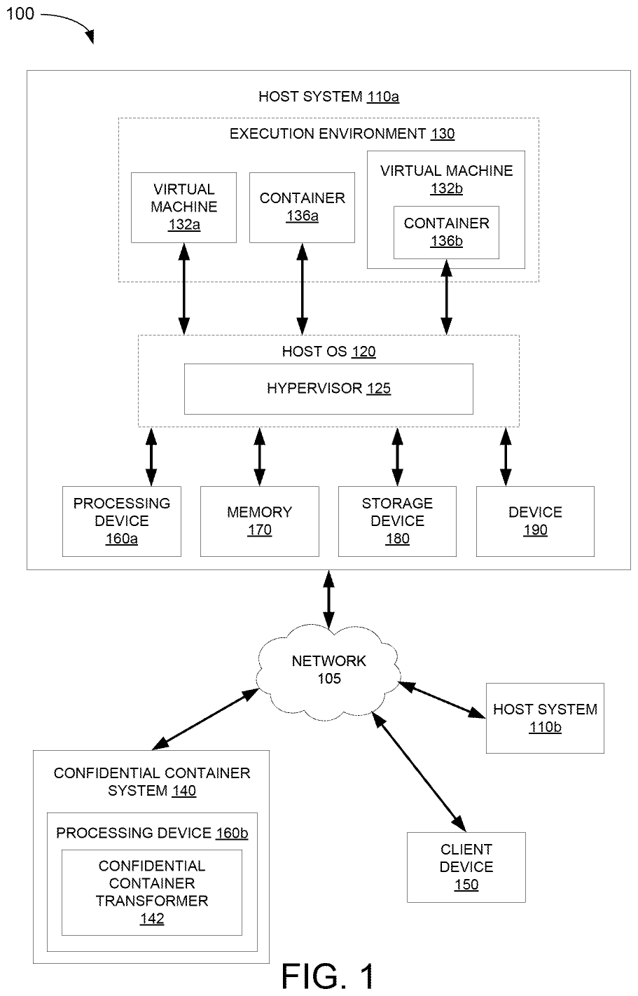

FIG. 1 is a block diagram that illustrates an example confidential container architecture 100, in accordance with some embodiments. However, other confidential container architectures are possible, and the implementation of a computer system utilizing examples of the disclosure are not necessarily limited to the specific architecture depicted by FIG. 1.

As shown in FIG. 1, confidential container architecture 100 includes host systems 110a and 110b, confidential container system 140, and client device 150. The host systems 110a and 110b, confidential container system 140, and client device 150 may each include hardware such as processing devices 160a and 160b, memory 170, which may include volatile memory devices, e.g., random access memory (RAM), non-volatile memory devices, e.g., flash memory, and/or other types of memory devices, a storage device 180, e.g., one or more magnetic hard disk drives, a Peripheral Component Interconnect (PCI) solid state drive, a Redundant Array of Independent Disks (RAID) system, or a network attached storage (NAS) array, and one or more devices 190, e.g., a Peripheral Component Interconnect (PCI) device, a network interface controller (NIC), a video card, or an I/O device. In certain implementations, memory 170 may be non-uniform access (NUMA), such that memory access time depends on the memory location relative to processing devices 160a and 160b. It should be noted that although, for simplicity, a single processing device 160a or 160b, storage device 180, and device 190 are depicted in FIG. 1, other embodiments of host systems 110a and 110b, confidential container system 140, and client device 150 may include multiple processing devices, storage devices, or devices. Processing devices 160a and 160b may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing devices 160a and 160b may also include one or more special-purpose processing devices such as an application specific integrated circuit (ASIC), a field programmable gate array (FPGA), a digital signal processor (DSP), network processor, or the like.

Each of the host systems 110a and 110b, confidential container system 140, and client device 150 may be a server, a mainframe, a workstation, a personal computer (PC), a mobile phone, a palm-sized computing device, etc. In some embodiments, host systems 110a and 110b, confidential container system 140, and/or client device 150 may be separate computing devices. In some embodiments, host systems 110a and 110b, confidential container system 140, and/or client device 150 may be implemented by a single computing device. For clarity, some components of confidential container system 140, host system 110b, and client device 150 are not shown. In some embodiments, the confidential container system 140 may include a container-orchestration system. Furthermore, although confidential container architecture 100 is illustrated as having two host systems, embodiments of the disclosure may utilize any number of host systems.

Host systems 110a and 110b may additionally include execution environments 130, which may include one or more virtual machines (VMs) 132a, containers 136a, containers 136b residing within virtual machines 132b, and a host operating system (OS) 120. VM 132a and VM 132b are software implementations of machines that execute programs as though they were actual physical machines. Containers 136 act as isolated execution environments for different workloads of services, as previously described. Host OS 120 manages the hardware resources of the computer system and provides functions such as inter-process communication, scheduling, memory management, and so forth.

Host OS 120 may include a hypervisor 125, which may also be known as a virtual machine monitor (VMM), can provide a virtual operating platform for VMs 132a and 132b and manages their execution. Hypervisor 125 may manage system resources, including access to physical processing devices, e.g., processors or CPUs, physical memory, e.g., RAM, storage devices, e.g., HDDs or SSDs, and/or other devices, e.g., sound cards or video cards. The hypervisor 125, though typically implemented in software, may emulate and export a bare machine interface to higher level software in the form of virtual processors and guest memory. Higher level software may comprise a standard or real-time OS, may be a highly stripped-down operating environment with limited operating system functionality, and/or may not include traditional OS facilities, etc. Hypervisor 125 may present other software, i.e., “guest” software, the abstraction of one or more VMs that provide the same or different abstractions to various guest software, e.g., a guest operating system or guest applications. It should be noted that in some alternative implementations, hypervisor 125 may be external to host OS 120, rather than embedded within host OS 120, or may replace host OS 120.

The host systems 110a and 110b, confidential container system 140, and client device 150 are coupled to each other, e.g., may be operatively coupled, communicatively coupled, or may communicate data/messages with each other, via network 105. Network 105 may be a public network, e.g., the internet, a private network, e.g., a local area network (LAN) or a wide area network (WAN), or a combination thereof. In one embodiment, network 105 may include a wired or a wireless infrastructure, which may be provided by one or more wireless communications systems, such as a WiFi™ hotspot connected with the network 105 and/or a wireless carrier system that can be implemented using various data processing equipment, communication towers, e.g., cell towers. The network 105 may carry communications, e.g., data, message, packets, or frames, between the various components of host systems 110a and 110b, confidential container system 140, and/or client device 150.

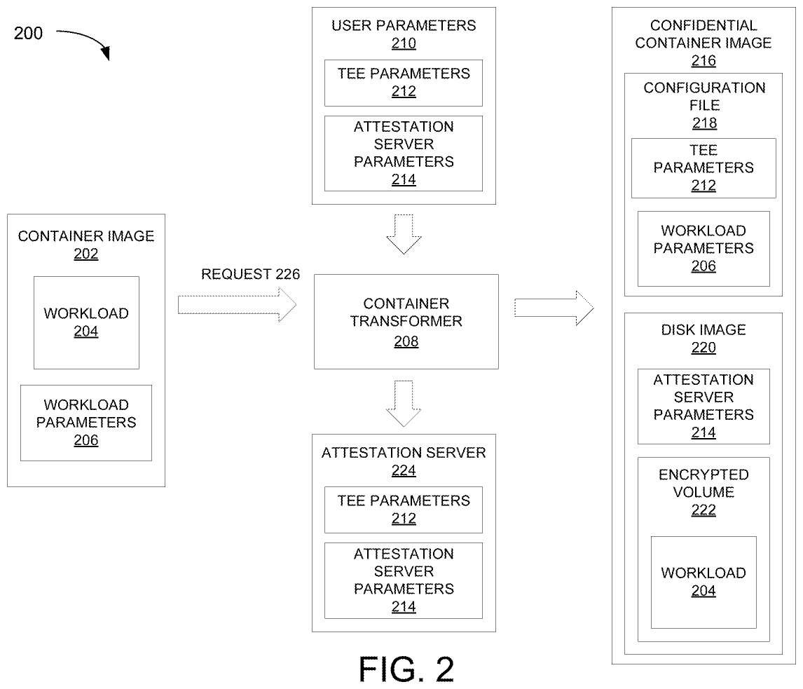

In some embodiments, processing device 160b may execute a confidential container transformer 142. The confidential container transformer 142 may receive a request from client device 150 to execute a workload. The confidential container transformer 142 may identify communication endpoints for execution environment(s) that are to execute the workload at host system 110a and/or host system 110b. The confidential container transformer 142 may configure the network connections to facilitate communication between the execution environment(s) and the client device 150. Further details regarding confidential container transformer 142 will be discussed at FIGS. 2-12 below.

In some embodiments, a user executes a tool that transforms a container image into a confidential container image, specifying the container image to be transformed along with parameters defining a TEE where the confidential container image is going to be executed and attestation server parameters. In some embodiments, the tool inspects the container image and extracts workload parameters associated with the container image. In some embodiments, the tool generates a random encryption key. In some embodiments, the tool creates a disk image with two partitions and writes the attestation server parameters into the first partition. In some embodiments, using the random encryption key, the tool creates an encrypted volume in the second partition of the disk image and copies the contents of the container image into the encrypted volume.

In some embodiments, the tool writes the workload parameters extracted from the container image into a configuration file. In some embodiments, the tool writes the TEE parameters specified by the user into the configuration file. In some embodiments, the tool creates an empty second container image. In some embodiments, this second container image will become a confidential container image. In some embodiments, the tool copies the disk image and the configuration file into the second container image. In some embodiments, the tool contacts an attestation server to register (or enroll) the new confidential container image. In some embodiments, registration includes providing the hash of the confidential container image, the random encryption key, and the contents of the configuration file.

In some embodiments, to deploy a confidential container image, a user requests the execution of the newly created confidential container image using regular container tools that have been extended to support these kind of images. In some embodiments, the container tools obtain the confidential container image from a registry and expand it into a local directory in an execution environment. A container runtime detects the existence of the configuration file within the confidential container image and launches a TEE using an embedded VMM (Virtual Machine Monitor), e.g., libkrun. In some embodiments, the embedded VMM reads the configuration file and creates a Virtualization-based TEE based on the contents of the configuration file. In some embodiments, the Virtualization-based TEE contacts a specified attestation server providing its signed launch measurement. A secure processor maintains a trusted computing base (TCB) identity digest, similar to Trusted Platform Module (TPM)'s extended hash platform register (PCR) called “ReportedTCB,” which can be used to derive a VCEK for signing a remote attestation report. In some embodiments, a signed launch measurement is data obtained from a signed attestation report. In some embodiments, during a remote attestation process, a guest VM will be challenged to request attestation reports through a trusted channel with a secure processor. The secure processor will collect a set of measures including device and TCB identity to generate a remote attestation report. This signed attestation report will be received and verified by relying parties (guest owners) against reference values and corresponding supply chain endorser entity, e.g., the authentic chip vendor.

In some embodiments, the attestation server verifies that the received launch measurement matches the expected values according to the confidential container image parameters. In some embodiments, if the values match, the attestation server sends the encryption key of the encrypted volume of the disk image. In some embodiments, upon receipt of the encryption key from the attestation server, the Virtualization-based TEE opens the encrypted volume of the disk image, reads the workload parameters to set up an environment, and launches the workload at the workload's designated “entry point.”

FIG. 2 is a flow diagram of a transformation process 200 for a confidential container image, in accordance with some embodiments. FIG. 2 includes a container image 202, user parameters 206, a confidential container transformer 212, a confidential container image 216, and an attestation server 224. In some embodiments, confidential container transformer 212 may correspond to confidential container transformer 142 of FIG. 1. In some embodiments, attestation server 224 may correspond to host system 110a of FIG. 1. In some embodiments, container image 202 may include a workload 204 and workload parameters 208. In some embodiments, user parameters 210 may include TEE parameters 212 and attestation server parameters 214. In some embodiments, confidential container image 216 may include configuration file 218 and disk image 220. In some embodiments, configuration file 218 may include workload parameters 206 and TEE parameters 212. In some embodiments, disk image 220 may include attestation server parameters 214 and encrypted volume 222. In some embodiments, encrypted volume 222 may include workload 204.

Referring to FIG. 2, container image 202 includes a workload 204 that is to be executed by one or more execution environments, e.g., containers 136a and 136b of FIG. 1, that are supported by one or more host systems (not shown) of the confidential container architecture 200. Upon identifying the container image 202 that is to be transformed, a client device, such as client device 150 of FIG. 1 may generate a request 226 that includes a container image 202 and user parameters 210 to generate a confidential container image 216 to be deployed to an execution environment. In some embodiments, the user parameters 210 may include TEE parameters 212 and attestation server parameters 214. In some embodiments, the attestation parameters may designate a particular attestation server that can authenticate a resulting confidential container image 216. In some embodiments, container transformer 208 can consume a container image 202 and user parameters 210, and construct a confidential container image 216. In some embodiments, container transformer 208 extracts workload parameters 206 for a workload 204 that are included in a container image 202. In some embodiments, container transformer 208 creates a disk image 220. In some embodiments, disk image 220 is created with two partitions. In some embodiments, container transformer 208 writes attestation server parameters 214 into the first partition of the disk image. In some embodiments, container transformer 208 generates a random encryption key and creates an encrypted volume in the second partition of the disk image using the random encryption key. In some embodiments, container transformer 208 copies container image 202 into the encrypted volume. In some embodiments, container transformer 208 creates a configuration file containing TEE parameters 212 and workload parameters 206.

In some embodiments, container transformer 208 creates a new confidential container image 216 and writes the disk image 220 and the configuration file 218 to confidential container image 216. In some embodiments, container transformer 208 contacts an attestation server 224 to enroll, or register, the confidential container image 216. In some embodiments, as part of the registration, container transformer 208 sends a hash of the confidential container image 216, the random encryption key, and the TEE parameters 212.

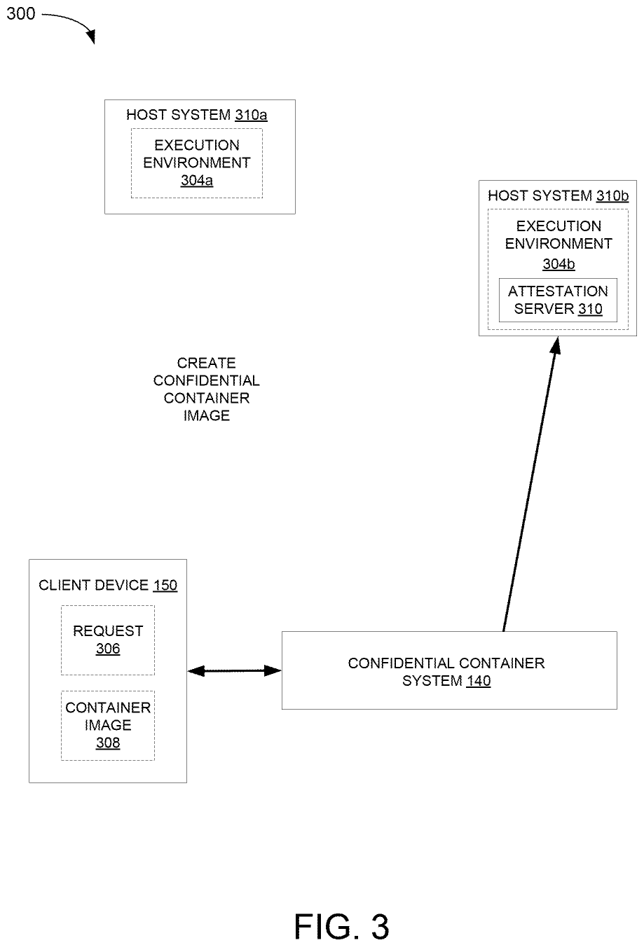

FIG. 3 is a depiction of an example of a client device transmitting a request to create a confidential container image in a confidential container architecture 300, in accordance with embodiments of the disclosure. Confidential container architecture 300 may correspond to confidential container architecture 100, as previously described at FIG. 1. For clarity, some elements of the confidential container architecture 100 are not shown.

Referring to FIG. 3, client device 150 includes a request 306 and a container image 308 that is to be transformed by confidential container system 140 for deployment to one or more execution environments, e.g., execution environment 304a, which are supported by one or more host systems, e.g., host system 310a, of the confidential container architecture 300. FIG. 3 also includes attestation server 310, running within execution environment 304b, on host system 310b. In some embodiments, container image 308 may be similar to container image 202 of FIG. 2. In some embodiments, attestation server 310 may be similar to attestation server 224 of FIG. 2. Upon identifying the container image 308 that is to be transformed, the client device 150 may generate a request 306 that includes parameters for the confidential container system 140 that is to transform container image 308 into a confidential container image. It should be noted that request 306 and container image 308 are shown for illustrative purposes only and are not physical components of client device 150.

In FIG. 3, the request 306 includes identification information for host system 310b, execution environment 304b, and attestation server 310, indicating that attestation server 310 is to be used to provide attestation for future deployments of the confidential container to be generated from container image 308. Upon generating the request 306, the client device 150 may transmit the request 306 that includes the identification information to the confidential container system 140. The confidential container system 140 may use the identification information included in the request 306 to provide user parameters that are indicated in the request 306. In some embodiments, the user parameters may be similar to the user parameters 210 of FIG. 2.

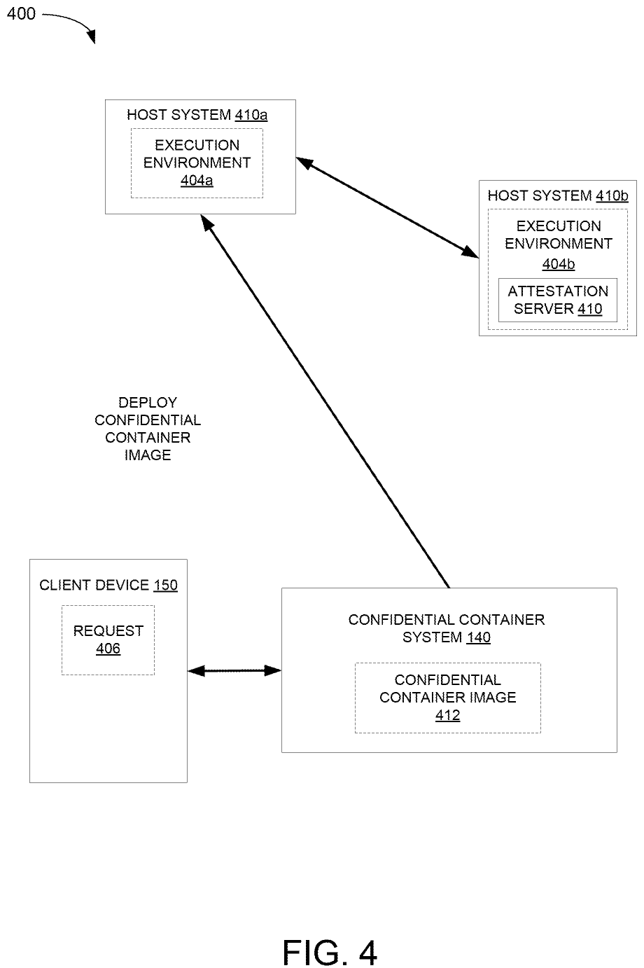

FIG. 4 is a depiction of an example of a client device transmitting a request to deploy a confidential container of a confidential container architecture 400, in accordance with embodiments of the disclosure. Confidential container architecture 400 may correspond to confidential container architecture 100, as previously described at FIG. 1. For clarity, some elements of the confidential container architecture 100 are not shown.

Referring to FIG. 4, client device 150 includes a request 406 that is to be executed by confidential container system 140 of the confidential container architecture 400. Upon identifying the confidential container image 408 that is to be deployed, the client device 150 may generate a request 406 that includes identification information for the one or more execution environments to which confidential container image 408 is to be deployed. In some embodiments, host systems 410a and 410b may correspond to host system 110a of FIG. 1. In some embodiments, the client device 150 may determine the identification information in view of the confidential container image 408 that is to be deployed. For example, confidential container image 408 may be associated with an application executed by execution environment 404a and the application may indicate other execution environments that are to be used to deploy confidential container image 408. In an embodiment, the client device 150 may utilize other criteria to determine the identification information for the one or more execution environments. It should be noted that request 406 and confidential container image 408 are shown for illustrative purposes only and are not physical components of client device 150.

In FIG. 4, the confidential container image 408 includes identification information for attestation server 410, indicating that attestation server 410 is to be used to deploy confidential container image 408. Upon generating the request 406, the client device 150 may transmit the request 406 that includes the identification information to the confidential container provisioning system 140. The confidential container provisioning system 140 may use the identification information included in the request 406 to identify host system 410a and execution environment 404a that are indicated in the request 406. In some embodiments, execution environment 410a may perform a pull of the confidential container image from the confidential container system 140. In some embodiments, container tools on execution environment 410a expand the confidential container image 408 and expand it into a local directory. In some embodiments, a container runtime detects the existence of a configuration file and enables a code path to launch a TEE using an embedded VMM. In some embodiments, the configuration file corresponds to the configuration file 218 of FIG. 2.

In some embodiments, the embedded VMM reads the configuration file and creates a Virtualization-based TEE based on the contents of the configuration file. In some embodiments, the Virtualization-based TEE contacts attestation server 410, providing its signed launch measurement. In some embodiments, the attestation server verifies that the received launch measurement matches the expected value according to the confidential container image parameters. In some embodiments, if the launch measurement matches the expected value, the attestation server responds to the Virtualization-based TEE and provides the random encryption key used during the registration of the confidential container image with the attestation server. Upon receipt of the random encryption key, the Virtualization-based TEE opens the encrypted volume of the disk image included in the confidential container image 408 and begins executing the workload included in the encrypted volume. In some embodiments, the workload corresponds to the workload 204 of FIG. 2.

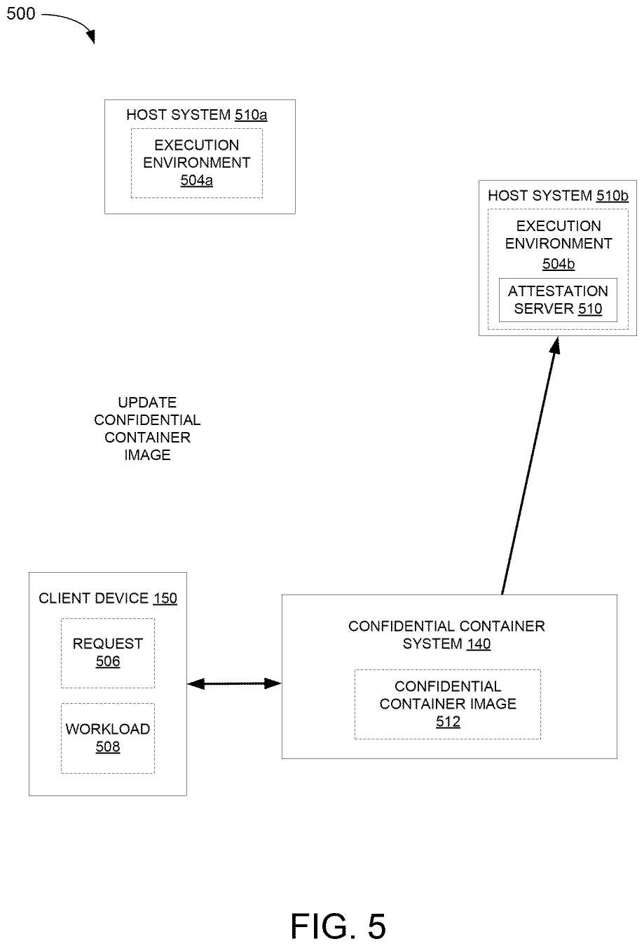

FIG. 5 is a depiction of an example of a client device transmitting an update to a confidential container of a confidential container architecture 500, in accordance with embodiments of the disclosure. Confidential container architecture 500 may correspond to confidential container architecture 100, as previously described at FIG. 1. For clarity, some elements of the confidential container architecture 100 are not shown.

Referring to FIG. 5, client device 150 includes a request 506 that is to be executed by confidential container system 140 of the confidential container architecture 500. Upon identifying the confidential container image 512 that is to be updated, the client device 150 may generate a request 506 that includes identification information for the one or more execution environments to which confidential container image 512 is to be updated. In some embodiments, the update includes workload 508, which may include a new container image to be incorporated in the updated confidential container image 512. In some embodiments, host systems 510a and 510b may correspond to host system 110a of FIG. 1. In some embodiments, the client device 150 may determine the identification information in view of the confidential container image 512 that is to be updated. For example, confidential container image 512 may be associated with an application executed by execution environment 504a and the application may indicate other execution environments that are to be used to deploy confidential container image 512. In an embodiment, the client device 150 may utilize other criteria to determine the identification information for the one or more execution environments. It should be noted that request 506, workload 508, and confidential container image 512 are shown for illustrative purposes only and are not physical components of client device 150.

In FIG. 5, the workload 508 and/or the confidential container image 512 may include identification information for attestation server 510, indicating that attestation server 510 is to be used to authenticate confidential container image 512. Upon generating the request 506, the client device 150 may transmit the request 506 and the workload 508 that include the identification information to the confidential container provisioning system 140. The confidential container provisioning system 140 may use the identification information included in the request 506 to identify host system 510a and execution environment 504a that are indicated in the request 506.

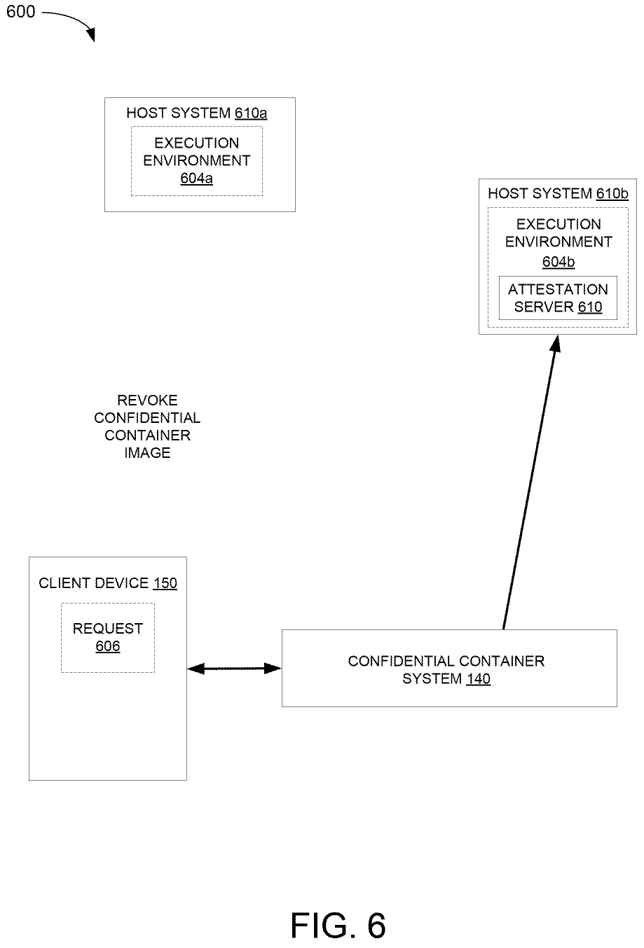

FIG. 6 is a depiction of an example of a client device transmitting a request to revoke a confidential container of a confidential container architecture 600, in accordance with embodiments of the disclosure. Confidential container architecture 600 may correspond to confidential container architecture 100, as previously described at FIG. 1. For clarity, some elements of the confidential container architecture 100 are not shown.

Referring to FIG. 6, client device 150 includes a request 606 that is to be executed by confidential container system 140 of the confidential container architecture 600. Upon identifying the confidential container image that is to be revoked, the client device 150 may generate a request 606 that includes identification information for the confidential container image that is to be revoked. In some embodiments, host systems 610a and 610b may correspond to host system 110a of FIG. 1. In some embodiments, the client device 150 may determine the identification information in view of the confidential container image that is to be revoked. For example, the confidential container image may be associated with an application executed by execution environment 604a and the application may indicate other execution environments that have deployed the confidential container image. In some embodiments, the confidential container system may maintain an inventory of host systems and/or execution environments to which the confidential container has been deployed. In some embodiments, the client device 150 may utilize other criteria to determine the identification information for the one or more execution environments. It should be noted that request 606 is shown for illustrative purposes only and is not a physical component of client device 150.

In FIG. 6, the workload 606 and/or the confidential container image include identification information for attestation server 610, indicating that attestation server 610 is to be used to authenticate the confidential container image. Upon generating the request 606, the client device 150 may transmit the request 606 to the confidential container provisioning system 140. The confidential container provisioning system 140 may use the identification information included in the request 606 or in the confidential container image to identify attestation server 610. Upon identification of the appropriate attestation server 610, in some embodiments, confidential container system 140 sends instructions to attestation server 140 to delete the launch measurement from attestation server 140. In some embodiments, the confidential container system 140 sends instructions to attestation server 140 to mark the confidential container as invalid. In some embodiments, confidential container system 140 may delete the confidential container.

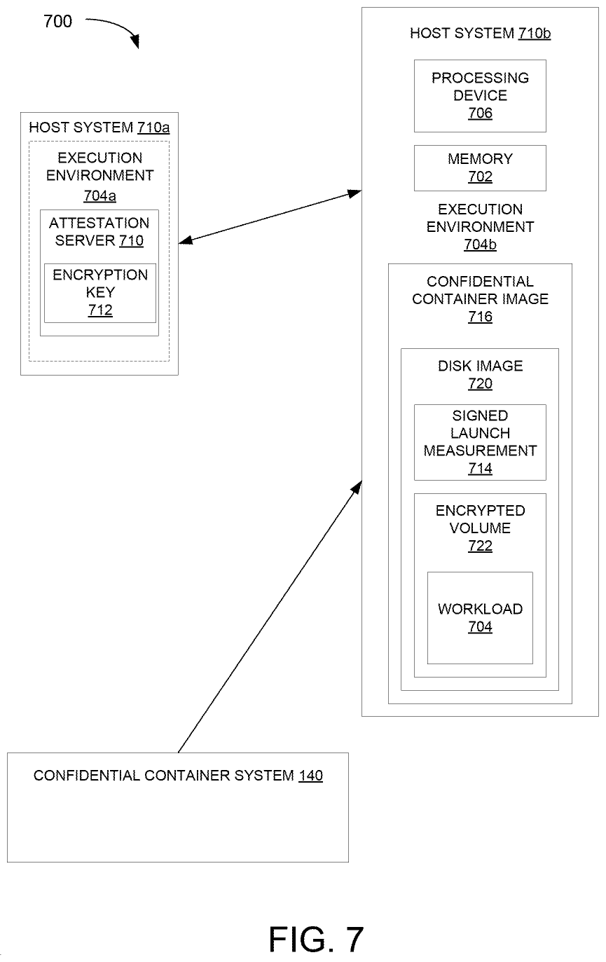

FIG. 7 is a component diagram depicting an example confidential container architecture 700, in accordance with embodiments of the disclosure. The confidential container architecture 700 includes host system 710a, execution environments 704a and 704b, processing device 706, memory 702, and confidential container system 140. Host system 710a may correspond to host system 110a of FIG. 1. Execution environments 704a and 704b may correspond to execution environment 104a of FIG. 1. Execution environments 704a and 704b may include VMs, containers, or one or more containers within a VM. Although illustrated as each having one execution environment, in some embodiments host system 710a may include any number of execution environments. Confidential container system 140 may correspond to confidential container system 140 of FIG. 1. In some embodiments, processing device 706 may correspond to 160a of FIG. 1. In some embodiments, memory 702 may include volatile memory devices, e.g., random access memory (RAM), non-volatile memory devices, e.g., flash memory, and/or other types of memory devices.

Execution environment 704b may obtain a confidential container image 716 from confidential container system 140. In some embodiments, execution environment 704b may provide a signed launch measurement to attestation server 710. In some embodiments, attestation server 710 may correspond to attestation server 224 of FIG. 2. Execution environment 704b may, in response to obtaining an encryption key 712 from the attestation server 710, open an encrypted volume 722 of the confidential container image 716. In some embodiments, encrypted volume 722 may correspond to encrypted volume 222 of FIG. 2. In some embodiments, the execution environment 704b may execute a workload 704 obtained from the encrypted volume 722. It should be noted that confidential container image 716, encryption key 712, disk image 720, signed launch parameters 714, and encrypted volume 722 are shown for illustrative purposes only and are not physical components of host system 710b or host system 710a.

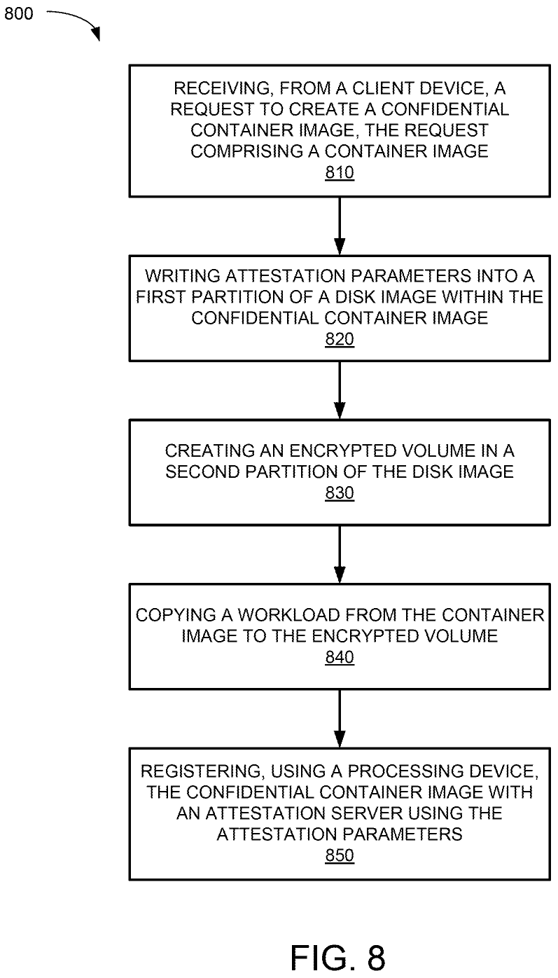

FIG. 8 is a flow diagram of a method 800 of provisioning a confidential container, in accordance with some embodiments. Method 800 may be performed by processing logic that may comprise hardware, e.g., circuitry, dedicated logic, programmable logic, a processor, a processing device, a central processing unit (CPU), a system-on-a-chip (SoC), software, e.g., instructions running/executing on a processing device, firmware, e.g., microcode, or a combination thereof. In some embodiments, at least a portion of method 800 may be performed by confidential container transformer 142 of FIG. 1.

With reference to FIG. 8, method 800 illustrates example functions used by various embodiments. Although specific function blocks (“blocks”) are disclosed in method 800, such blocks are examples. That is, some embodiments are well suited to performing various other blocks or variations of the blocks recited in method 800. It is appreciated that the blocks in method 800 may be performed in an order different than presented, and that not all of the blocks in method 800 may be performed.

Method 800 begins at block 810, where the processing logic receives, from a client device, a request to create a confidential container image, the request comprising a container image. In some embodiments, the container image corresponds to container image 202 of FIG. 2. In some embodiments, the confidential container image corresponds to confidential container image 216 of FIG. 2. In some embodiments, the tool inspects the container image and extracts workload parameters associated with the container image.

At block 820, the processing logic writes attestation parameters into a first partition of a disk image within the confidential container image. In some embodiments, the processing logic creates a disk image with two partitions. In some embodiments, the disk image corresponds to disk image 220 of FIG. 2. In some embodiments, the processing logic creates a new, empty, container image and copies the disk image and a configuration file to the new container image. In some embodiments, the new container image corresponds to the confidential container image 216 of FIG. 2. In some embodiments, the processing logic writes workload parameters extracted from the container image into a configuration file. In some embodiments, the workload parameters correspond to workload parameters 206 of FIG. 2. In some embodiments, the processing logic writes TEE parameters specified by the user into the configuration file. In some embodiments, the TEE parameters correspond to TEE parameters 212 of FIG. 2.

At block 830, the processing logic creates an encrypted volume in a second partition of the disk image. In some embodiments, the encrypted volume corresponds to encrypted volume 222 of FIG. 2. In some embodiments, the disk image has two partitions. In some embodiments, the tool generates a random encryption key. In some embodiments, the tool creates the encrypted volume in a second partition of the disk image, using the random encryption key.

At block 840, the processing logic copies a workload from the container image to the encrypted volume. In some embodiments, the workload corresponds to workload 204 of FIG. 2.

At block 850, the processing logic registers the disk image, as a confidential container image, with an attestation server. In some embodiments, registration includes providing the hash of the confidential container image, the random encryption key, and the contents of the configuration file to the attestation server.

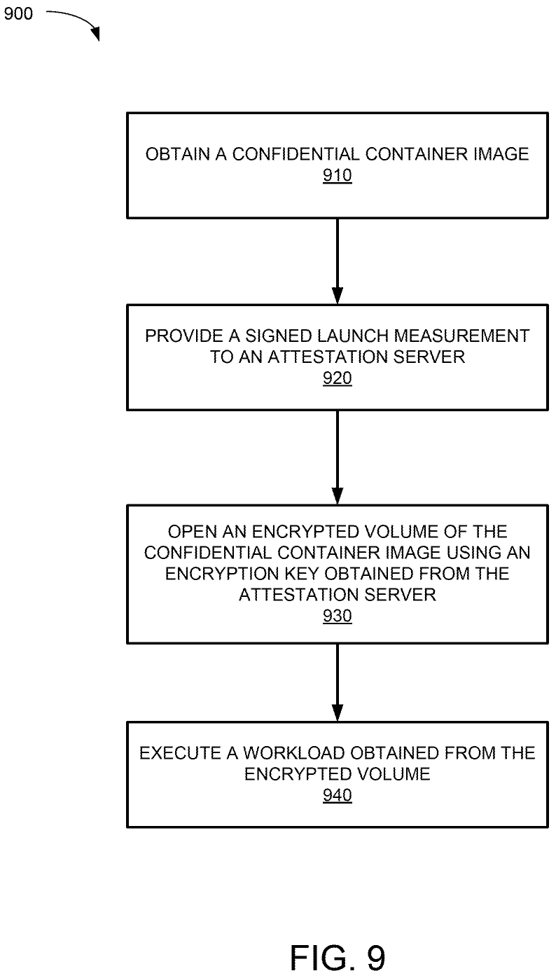

FIG. 9 is a flow diagram of a method 900 of deploying, a confidential container, in accordance with some embodiments. Method 900 may be performed by processing logic that may comprise hardware, e.g., circuitry, dedicated logic, programmable logic, a processor, a processing device, a central processing unit (CPU), a system-on-a-chip (SoC), software, e.g., instructions running/executing on a processing device, firmware, e.g., microcode, or a combination thereof. In some embodiments, at least a portion of method 900 may be performed by confidential container transformer 142 of FIG. 1.

With reference to FIG. 9, method 900 illustrates example functions used by various embodiments. Although specific function blocks (“blocks”) are disclosed in method 900, such blocks are examples. That is, embodiments are well suited to performing various other blocks or variations of the blocks recited in method 900. It is appreciated that the blocks in method 900 may be performed in an order different than presented, and that not all of the blocks in method 900 may be performed.

Method 900 begins at block 910, where the processing logic obtains a confidential container image. In some embodiments, obtaining the confidential container image may include performing a pull of the confidential container image from a confidential container system. In some embodiments, the confidential container system may correspond to the confidential container system 140 of FIG. 1. In some embodiments, obtaining a confidential container image comprises expanding the confidential container image into a local directory. In some embodiments, obtaining a confidential container image comprises launching a TEE using an embedded VMM. In some embodiments, a container runtime detects the existence of a configuration file and enables a code path to launch the TEE. In some embodiments, the configuration file corresponds to the configuration file 218 of FIG. 2. In some embodiments, the confidential container image is OCI compliant.

At block 920, the processing logic provides a signed launch measurement to an attestation server. In some embodiments, the attestation server corresponds to attestation server 224 of FIG. 2.

At block 930, the processing logic opens an encrypted volume of the confidential container image using an encryption key obtained from the attestation server.

At block 940, the processing logic executes a workload obtained from the encrypted volume. In some embodiments, the workload corresponds to the workload 204 of FIG. 2. In some embodiments, executing the workload comprises applying workload parameters obtained from a configuration file in the confidential container image.

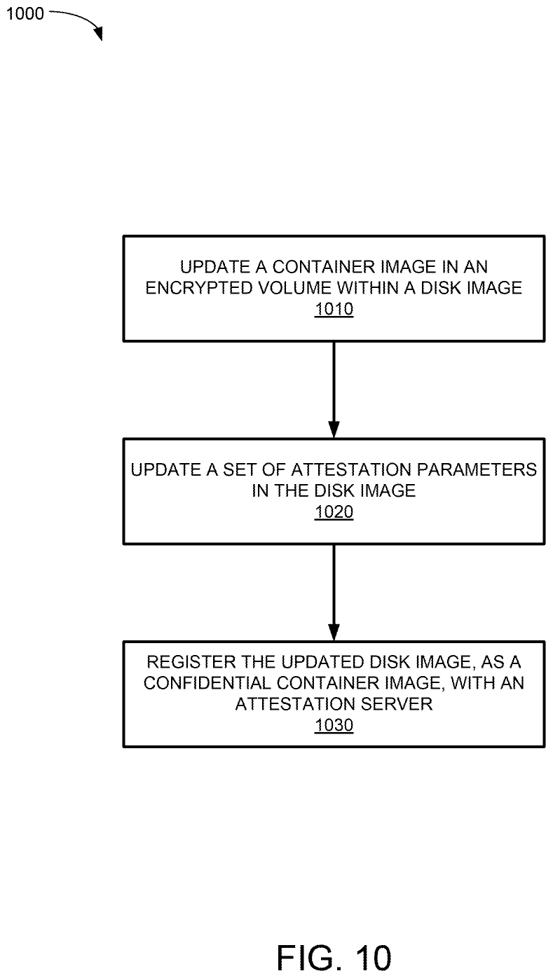

FIG. 10 is a flow diagram of a method 1000 of updating a confidential container, in accordance with some embodiments. Method 1000 may be performed by processing logic that may comprise hardware, e.g., circuitry, dedicated logic, programmable logic, a processor, a processing device, a central processing unit (CPU), a system-on-chip (SoC), software, e.g., instructions running/executing on a processing device, firmware, e.g., microcode, or a combination thereof. In some embodiments, at least a portion of method 1000 may be performed by confidential container transformer 142 of FIG. 1.

With reference to FIG. 10, method 1000 illustrates example functions used by various embodiments. Although specific function blocks (“blocks”) are disclosed in method 1000, such blocks are examples. That is, embodiments are well suited to performing various other blocks or variations of the blocks recited in method 1000. It is appreciated that the blocks in method 1000 may be performed in an order different than presented, and that not all of the blocks in method 1000 may be performed.

Method 1000 begins at block 1010, where the processing logic receives, from a client device, a request to update a container image in an encrypted volume within a disk image. In some embodiments, the processing logic copies a container image to an existing encrypted volume within a disk image. In some embodiments, the encrypted volume and the disk image correspond to encrypted volume 222 and disk image 220 of FIG. 2. In some embodiments, the tool inspects the container image and extracts workload parameters associated with the container image. In some embodiments, the tool generates a new random encryption key. In some embodiments, the tool replaces an encrypted volume in a second partition of the disk image, using the new random encryption key, and copies the contents of the container image into the encrypted volume.

At block 1020, the processing logic updates a set of attestation parameters in the disk image. In some embodiments, the processing logic writes an updated set of attestation parameters to the disk image. In some embodiments, the tool writes the attestation server parameters into the first partition of the disk image. In some embodiments, the processing logic copies the disk image and a configuration file to an existing container image. In some embodiments, the existing container image corresponds to the confidential container image 216 of FIG. 2. In some embodiments, the processing logic writes workload parameters extracted from the container image into a new configuration file. In some embodiments, the workload parameters correspond to workload parameters 206 of FIG. 2. In some embodiments, the processing logic writes TEE parameters specified by the user into the new configuration file. In some embodiments, the TEE parameters correspond to TEE parameters 212 of FIG. 2. In some embodiments, the new configuration file is written to the confidential container image.

At block 1030, the processing logic registers the updated disk image, as a confidential container image, with an attestation server. In some embodiments, registration includes providing the hash of the updated confidential container image, the new random encryption key, and the contents of the new configuration file to the attestation server.

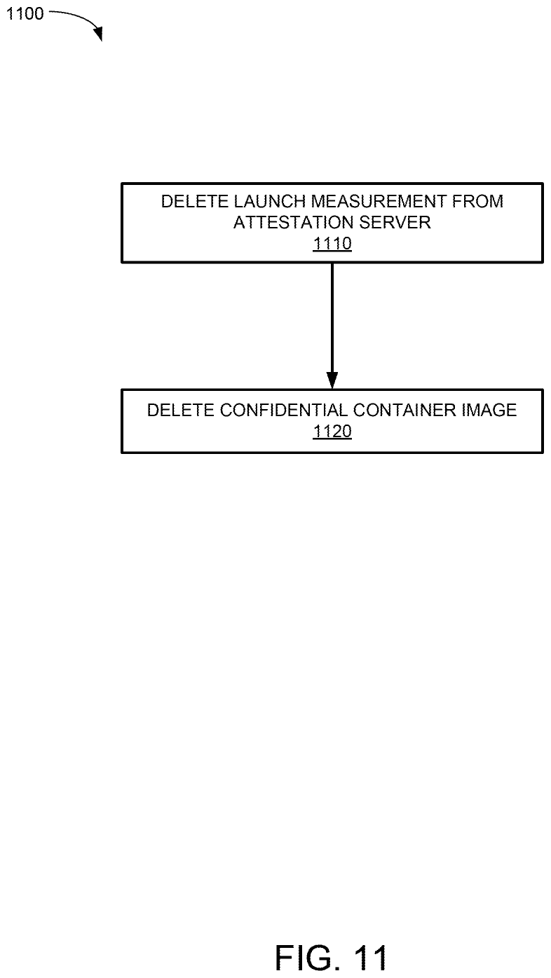

FIG. 11 is a flow diagram of a method 1100 of revoking a confidential container, in accordance with some embodiments. Method 1100 may be performed by processing logic that may comprise hardware, e.g., circuitry, dedicated logic, programmable logic, a processor, a processing device, a central processing unit (CPU), or a system-on-chip (SoC), software, e.g., instructions running/executing on a processing device, firmware, e.g., microcode, or a combination thereof. In some embodiments, at least a portion of method 1100 may be performed by confidential container transformer 142 of FIG. 1.

With reference to FIG. 11, method 1100 illustrates example functions used by various embodiments. Although specific function blocks (“blocks”) are disclosed in method 1100, such blocks are examples. That is, embodiments are well suited to performing various other blocks or variations of the blocks recited in method 1100. It is appreciated that the blocks in method 1100 may be performed in an order different than presented, and that not all of the blocks in method 1100 may be performed.

Method 1100 begins at block 1110, where the processing logic deletes the launch measurement from the attestation server. In some embodiments, the attestation server may correspond to attestation server 224 of FIG. 2. In some embodiments, rather than deletion, the attestation server may mark the launch measurement as invalid.

At block 1120, the processing logic deletes the confidential container image. In some embodiments, the confidential container image may be stored in a repository. In some embodiments, the confidential container image may be stored in a confidential container system. In some embodiments, the confidential container system may correspond to the confidential container system 140 of FIG. 1.

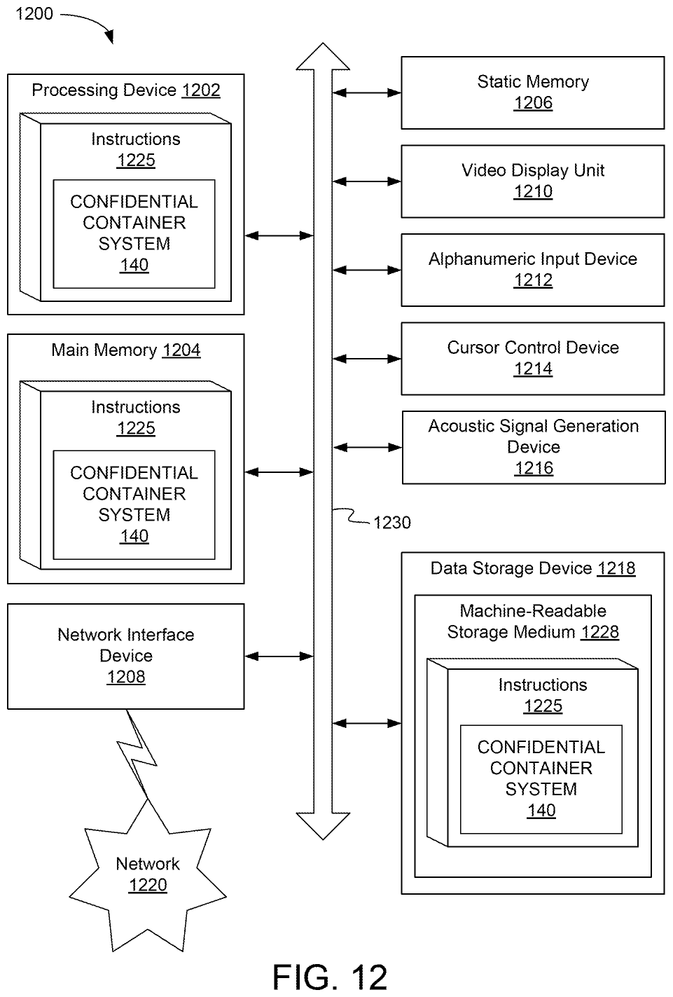

FIG. 12 is a block diagram of an example computing device 1200 that may perform one or more of the operations described herein, in accordance with some embodiments. Computing device 1200 may be connected to other computing devices in a LAN, an intranet, an extranet, and/or the Internet. The computing device may operate in the capacity of a server machine in client-server network environment or in the capacity of a client in a peer-to-peer network environment. The computing device may be provided by a personal computer (PC), a set-top box (STB), a server, a network router, a switch or bridge, or any machine capable of executing a set of instructions (sequential or otherwise) that specify actions to be taken by that machine. Further, while only a single computing device is illustrated, the term “computing device” shall also be taken to include any collection of computing devices that individually or jointly execute a set (or multiple sets) of instructions to perform the methods discussed herein.

The example computing device 1200 may include a processing device 1202, e.g., a general-purpose processor or a programmable logic device (PLD), a main memory 1204, e.g., a synchronous dynamic random-access memory (DRAM) or a read-only memory (ROM), a static memory 1206, e.g., flash memory, and a data storage device 1218, which may communicate with each other via a bus 1230.

Processing device 1202 may be provided by one or more general-purpose processing devices such as a microprocessor, central processing unit, or the like. In an illustrative example, processing device 1202 may include a complex instruction set computing (CISC) microprocessor, reduced instruction set computing (RISC) microprocessor, very long instruction word (VLIW) microprocessor, or a processor implementing other instruction sets or processors implementing a combination of instruction sets. Processing device 1202 may also include one or more special-purpose processing devices such as an application specific integrated circuit (ASIC), a field programmable gate array (FPGA), a digital signal processor (DSP), a network processor, or the like. The processing device 1202 may be configured to execute the operations described herein, in accordance with one or more aspects of the present disclosure, for performing the operations and steps discussed herein.

Computing device 1200 may further include a network interface device 1208 which may communicate with a network 1220. The computing device 1200 also may include a video display unit 1210, e.g., a liquid crystal display (LCD) or a cathode ray tube (CRT), an alphanumeric input device 1212, e.g., a keyboard, a cursor control device 1214, e.g., a mouse, and an acoustic signal generation device 1216, e.g., a speaker. In one embodiment, video display unit 1210, alphanumeric input device 1212, and cursor control device 1214 may be combined into a single component or device, e.g., an LCD touch screen.

Data storage device 1218 may include a computer-readable storage medium 1228 on which may be stored one or more sets of instructions 1225 that may include instructions for a confidential container provisioning system 140, further including a confidential container transformer (not shown) for carrying out the operations described herein, in accordance with one or more aspects of the present disclosure. Instructions 1225 may also reside, completely or at least partially, within main memory 1204 and/or within processing device 1202 during execution thereof by computing device 1200, main memory 1204 and processing device 1202 also constituting computer-readable media. The instructions 1225 may further be transmitted or received over a network 1220 via network interface device 1208.

While computer-readable storage medium 1228 is shown in an illustrative example to be a single medium, the term “computer-readable storage medium” should be taken to include a single medium or multiple media, e.g., a centralized or distributed database and/or associated caches and servers, that store the one or more sets of instructions. The term “computer-readable storage medium” shall also be taken to include any medium that is capable of storing, encoding or carrying a set of instructions for execution by the machine and that cause the machine to perform the methods described herein. The term “computer-readable storage medium” shall accordingly be taken to include, but not be limited to, solid-state memories, optical media and magnetic media.

Example 1 is a method comprising: receiving, from a client device, a request to create a confidential container image, the request comprising a container image; writing attestation parameters into a first partition of a disk image within the confidential container image; creating an encrypted volume in a second partition of the disk image; copying a workload from the container image to the encrypted volume; and registering, using a processing device, the confidential container image with an attestation server using the attestation parameters.

Example 2 is the method of Example 1, wherein the method further comprises: extracting a set of workload parameters from the container image; and deploying the workload using the workload parameters.

Example 3 is the method of Example 2, wherein the set of workload parameters comprises: environment variables; an entry point of the workload; a set of arguments for the entry point of the workload; and a list of network ports to be exposed by the workload.

Example 4 is the method of Example 1, wherein registering the confidential container image comprises, providing to the attestation server: a hash of the container image within the encrypted volume; a key used to encrypt the encrypted volume; and a configuration file.

Example 5 is the method of Example 4, wherein the key is a random encryption key.

Example 6 is the method of Example 1, wherein the container image is Open Container Initiative (OCI) compliant.

Example 7 is the method of Example 1, wherein the confidential container image comprises: the disk image; and a configuration file.

Example 8 is a system comprising: a memory; and a processing device, operatively coupled to the memory, to: obtain a confidential container image; provide a signed launch measurement to an attestation server; open an encrypted volume of the confidential container image using an encryption key obtained from the attestation server; and execute a workload obtained from the encrypted volume.

Example 9 is the system of Example 8, wherein the confidential container image is OCI compliant.

Example 10 is the system of Example 8, wherein the key is a random encryption key.

Example 11 is the system of Example 8, wherein the confidential container image comprises a configuration file.

Example 12 is the system of Example 11, wherein to execute the workload is to apply a set of workload parameters obtained from the configuration file.

Example 13 is the system of Example 11, wherein the configuration file comprises Confidential Computing Trusted Execution Environment (TEE) parameters.

Example 14 is the system of Example 13, wherein the set of TEE parameters comprises a trusted computing base (TCB) identity digest.

Example 15 is a non-transitory computer-readable storage medium including instructions that, when executed by a processing device, cause the processing device to: receive, from a client device, a request to create a confidential container image, the request comprising a container image; write attestation parameters into a first partition of a disk image within the confidential container image; create an encrypted volume in a second partition of the disk image; copy a workload from the container image to the encrypted volume; and register the confidential container image with an attestation server using the attestation parameters.

Example 16 is the non-transitory computer-readable storage medium of Example 15, wherein the instructions further cause the processing device to extract a set of workload parameters from the container image; and deploy the workload using the workload parameters.

Example 17 is the non-transitory computer-readable storage medium of Example 16, wherein the set of workload parameters comprises: environment variables; an entry point of the workload; a set of arguments for the entry point of the workload; and a list of network ports to be exposed by the workload.

Example 18 is the non-transitory computer-readable storage medium of Example 15, wherein to register the confidential container image is to provide to the attestation server: a hash of the container image within the encrypted volume; a key used to encrypt the encrypted volume; and a configuration file.

Example 19 is the non-transitory computer-readable storage medium of Example 18, wherein the key is a random encryption key.

Example 20 is the non-transitory computer-readable storage medium of Example 15, wherein the container image is Open Container Initiative (OCI) compliant.

Example 21 is the non-transitory computer-readable storage medium of Example 15, wherein the confidential container image comprises: the disk image; and a configuration file.

Example 22 is a system comprising a memory; and a processing device, operatively coupled to the memory, to: receive, from a client device, a request to create a confidential container image, the request comprising a container image; write attestation parameters into a first partition of a disk image within the confidential container image; create an encrypted volume in a second partition of the disk image; copy a workload from the container image to the encrypted volume; and register the confidential container image with an attestation server using the attestation parameters.

Example 23 is the system of Example 22, wherein the system further comprises extract a set of workload parameters from the container image; and deploy the workload using the workload parameters.

Example 24 is the system of Example 23, wherein the set of workload parameters comprises: environment variables; an entry point of the workload; a set of arguments for the entry point of the workload; and a list of network ports to be exposed by the workload.

Example 25 is the system of Example 22, wherein to register the confidential container image is to provide to the attestation server: a hash of the container image within the encrypted volume; a key used to encrypt the encrypted volume; and a configuration file.

Example 26 is the system of Example 25, wherein the key is a random encryption key.

Example 27 is the system of Example 22, wherein the container image is Open Container Initiative (OCI) compliant.

Example 28 is the system of Example 22, wherein the confidential container image comprises: the disk image; and a configuration file.

Example 29 is a method comprising: obtaining a confidential container image; providing a signed launch measurement to an attestation server; opening an encrypted volume of the confidential container image using an encryption key obtained from the attestation server; and executing a workload obtained from the encrypted volume.

Example 30 is the method of Example 29, wherein the confidential container image is OCI compliant.

Example 31 is the method of Example 29, wherein the key is a random encryption key.

Example 32 is the method of Example 29, wherein the confidential container image comprises a configuration file.

Example 33 is the method of Example 32, wherein executing the workload further comprises applying a set of workload parameters obtained from the configuration file.

Example 34 is the method of Example 32, wherein the configuration file comprises TEE parameters.

Example 35 is the method of Example 34, wherein the set of TEE parameters comprises a TCB identity digest.

Example 36 is an apparatus comprising: means for receiving, from a client device, a request to create a confidential container image, the request comprising a container image; means for writing attestation parameters into a first partition of a disk image within the confidential container image; means for creating an encrypted volume in a second partition of the disk image; means for copying a workload from the container image to the encrypted volume; and means for registering the disk image, as a confidential container image, with an attestation server.

Example 37 is the apparatus of Example 36, wherein the apparatus further comprises: means for extracting a set of workload parameters from the container image; and means for deploying the workload using the workload parameters.

Example 38 is the apparatus of Example 37, wherein the set of workload parameters comprises: a set of environment variables; an entry point of the workload; a set of arguments for the entry point of the workload; and a list of network ports to be exposed by the workload.

Example 39 is the apparatus of Example 37, wherein means for registering the confidential container image comprises, means for providing to the attestation server: a hash of the container image within the encrypted volume; a key used to encrypt the encrypted volume; and a configuration file.

Example 40 is the apparatus of Example 39, wherein the key is a random encryption key.

Unless specifically stated otherwise, terms such as “copying,” “writing,” “registering,” “providing,” or the like, refer to actions and processes performed or implemented by computing devices that manipulate and transform data represented as physical (electronic) quantities within the computing device's registers and memories into other data similarly represented as physical quantities within the computing device memories or registers or other such information storage, transmission or display devices. Also, the terms “first,” “second,” “third,” “fourth,” etc., as used herein are meant as labels to distinguish among different elements and may not necessarily have an ordinal meaning according to their numerical designation.

Examples described herein also relate to an apparatus for performing the operations described herein. This apparatus may be specially constructed for the required purposes, or it may comprise a general-purpose computing device selectively programmed by a computer program stored in the computing device. Such a computer program may be stored in a computer-readable non-transitory storage medium.

The methods and illustrative examples described herein are not inherently related to any particular computer or other apparatus. Various general-purpose systems may be used in accordance with the teachings described herein, or it may prove convenient to construct more specialized apparatus to perform the required method steps. The required structure for a variety of these systems will appear as set forth in the description above.

The above description is intended to be illustrative and not restrictive. Although the present disclosure has been described with references to specific illustrative examples, it will be recognized that the present disclosure is not limited to the examples described. The scope of the disclosure should be determined with reference to the following claims, along with the full scope of equivalents to which the claims are entitled.

As used herein, the singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof. Therefore, the terminology used herein is for the purpose of describing particular embodiments only and is not intended to be limiting.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Although the method operations were described in a specific order, it should be understood that other operations may be performed in between described operations, described operations may be adjusted so that they occur at slightly different times, or the described operations may be distributed in a system which allows the occurrence of the processing operations at various intervals associated with the processing.

Various units, circuits, or other components may be described or claimed as “configured to” or “configurable to” perform a task or tasks. In such contexts, the phrase “configured to” or “configurable to” is used to connote structure by indicating that the units/circuits/components include structure, e.g., circuitry, that performs the task or tasks during operation. As such, the unit/circuit/component can be said to be configured to perform the task, or configurable to perform the task, even when the specified unit/circuit/component is not currently operational, e.g., is not on. The units/circuits/components used with the “configured to” or “configurable to” language include hardware, e.g., circuits and memory storing program instructions executable to implement the operation. Reciting that a unit/circuit/component is “configured to” perform one or more tasks, or is “configurable to” perform one or more tasks, is expressly intended not to invoke 35 U.S.C. § 112, sixth paragraph, for that unit/circuit/component. Additionally, “configured to” or “configurable to” can include generic structure, e.g., generic circuitry, that is manipulated by software and/or firmware, e.g., an FPGA or a general-purpose processor executing software, to operate in manner that is capable of performing the task(s) at issue. “Configured to” may also include adapting a manufacturing process, e.g., a semiconductor fabrication facility, to fabricate devices, e.g., integrated circuits, that are adapted to implement or perform one or more tasks. “Configurable to” is expressly intended not to apply to blank media, an unprogrammed processor or unprogrammed generic computer, or an unprogrammed programmable logic device, programmable gate array, or other unprogrammed device, unless accompanied by programmed media that confers the ability to the unprogrammed device to be configured to perform the disclosed function(s).

The foregoing description, for the purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the embodiments and its practical applications, to thereby enable others skilled in the art to best utilize the embodiments and various modifications as may be suited to the particular use contemplated. Accordingly, the present embodiments are to be considered as illustrative and not restrictive, and the invention is not to be limited to the details given herein, but may be modified within the scope and equivalents of the appended claims.

What is claimed is:

1. A method comprising:
receiving, from a client device, a request to create a confidential container image, the request comprising a container image;
writing attestation parameters into a first partition of a disk image within the confidential container image;
creating an encrypted volume in a second partition of the disk image;
copying a workload from the container image to the encrypted volume; and
registering, using a processing device, the confidential container image with an attestation server using the attestation parameters.

2. The method of claim 1, wherein the method further comprises:
extracting a set of workload parameters from the container image; and
deploying the workload using the workload parameters.

3. The method of claim 2, wherein the set of workload parameters comprises:
a set of environment variables;
an entry point of the workload;
a set of arguments for the entry point of the workload; and
a list of network ports to be exposed by the workload.

4. The method of claim 1, wherein registering the confidential container image comprises, providing to the attestation server:
a hash of the container image within the encrypted volume;
a key used to encrypt the encrypted volume; and
a configuration file.

5. The method of claim 4, wherein the key is a random encryption key.

6. The method of claim 1, wherein the container image is Open Container Initiative (OCI) compliant.

7. The method of claim 1, wherein the confidential container image comprises:
the disk image; and
a configuration file.

8. A system comprising:
a memory; and
a processing device, operatively coupled to the memory, to:
obtain a confidential container image;
provide a signed launch measurement to an attestation server;
open an encrypted volume of the confidential container image using an encryption key obtained from the attestation server; and
execute a workload obtained from the encrypted volume.

9. The system of claim 8, wherein the confidential container image is OCI compliant.

10. The system of claim 8, wherein the key is a random encryption key.

11. The system of claim 8, wherein the confidential container image comprises a configuration file.

12. The system of claim 11, wherein to execute the workload is to apply a set of workload parameters obtained from the configuration file.

13. The system of claim 11, wherein the configuration file comprises Confidential Computing Trusted Execution Environment (TEE) parameters.

14. The system of claim 13, wherein the set of TEE parameters comprises a trusted computing base (TCB) identity digest.

15. A non-transitory computer-readable storage medium including instructions that, when executed by a processing device, cause the processing device to:
receive, from a client device, a request to create a confidential container image, the request comprising a container image;
write attestation parameters into a first partition of a disk image within the confidential container image;
create an encrypted volume in a second partition of the disk image;
copy a workload from the container image to the encrypted volume; and
register the confidential container image with an attestation server using the attestation parameters.

16. The non-transitory computer-readable storage medium of claim 15, wherein the instructions further cause the processing device to:
extract a set of workload parameters from the container image; and
deploy the workload using the workload parameters.

17. The non-transitory computer-readable storage medium of claim 16, wherein the set of workload parameters comprises:
environment variables;
an entry point of the workload;
a set of arguments for the entry point of the workload; and
a list of network ports to be exposed by the workload.

18. The non-transitory computer-readable storage medium of claim 15, wherein to register the confidential container image is to provide to the attestation server:
a hash of the container image within the encrypted volume;
a key used to encrypt the encrypted volume; and
a configuration file.

19. The non-transitory computer-readable storage medium of claim 18, wherein the key is a random encryption key.

20. The non-transitory computer-readable storage medium of claim 15, wherein the container image is Open Container Initiative (OCI) compliant.
